(19) United States
(12) Patent Application Publication
(10) Pub. No.: US 2024/0388142 A1
(43) Pub. Date: Nov. 21, 2024

(54) MOTOR WITH SOUND MITIGATION FEATURE

(71) Applicant: MILWAUKEE ELECTRIC TOOL CORPORATION, Brookfield, WI (US)

(72) Inventors: Alexander J. Paulsen, St. Francis, WI (US); Ian A. Duncan, Colgate, WI (US)

(21) Appl. No.: 18/659,664

(22) Filed: May 9, 2024

Related U.S. Application Data
(60) Provisional application No. 63/581,762, filed on Sep. 11, 2023.
(60) Provisional application No. 63/467,454, filed on May 18, 2023.

(51) Int. Cl. H02K 1/14

(52) U.S. Cl. CPC H02K 1/146

(57) ABSTRACT

A motor includes a rotor having magnets therein and a stator. The stator includes a stator core having a ring and a plurality of teeth extending from the ring, a plurality of coils wrapped around the plurality of teeth, and a means for shifting a natural frequency of the motor to a frequency value outside a range of 2500 Hertz (Hz) to 3500 Hz.

### CROSS-REFERENCE TO RELATED APPLICATIONS

This application claims priority to U.S. Provisional Patent Application No. 63/581,762 filed on Sep. 11, 2023 and U.S. Provisional Patent Application No. 63/467,454 filed on May 18, 2023, the entire contents of both of which are incorporated herein by reference.

### FIELD OF THE DISCLOSURE

The present disclosure relates to motors, and more particularly to brushless direct current electric motors.

### BACKGROUND OF THE DISCLOSURE

The human ear perceives loudness of sound of different frequencies (Hz), at different loudness levels (phons). The human ear is susceptible to perceive frequencies of about 3,000 Hz. This is phenomena is represented by known equal-loudness Fletcher-Munson curves. Natural frequency of an object is the frequency (Hz) at which the object tends to oscillate in the absence of driving force. Vibrating objects of simple mass-spring systems include mass (kg) and stiffness (N/m). Stiffness is often defined as the extent to which an object resists deformation in response to an applied force. Natural frequency of a mass-spring system is the frequency at which the system would oscillate if there were no driving force and no damping force. Natural frequency is dependent on both the mass of the object and the stiffness of the spring.

### SUMMARY OF THE DISCLOSURE

The disclosure provides, in one aspect, a motor including a rotor having magnets therein and a stator. The stator includes a stator core having a ring and a plurality of teeth extending from the ring, a plurality of coils wound around the plurality of teeth, and a means for shifting a natural frequency of the motor to a frequency value outside a range of 2500 Hertz (Hz) to 3500 Hz.

The disclosure provides, in other aspects, a motor including a rotor having magnets therein and a stator. The stator includes a stator core having a ring and a plurality of teeth extending from the ring, and a plurality of coils wound around the plurality of teeth. The motor includes a means for shifting a natural frequency of the motor to a frequency value outside a range of 2500 Hertz (Hz) to 3500 Hz. The shifting means is also configured to apply a compressive force to the ring of the stator core.

The disclosure provides, in other aspects, a motor including a rotor having magnets therein and a stator. The stator includes a stator core having a ring and a plurality of teeth extending from the ring, a plurality of coils wound around the plurality of teeth, and a first means for shifting a natural frequency of the motor to a frequency value outside a range of 2500 Hertz (Hz) to 3500 Hz. The motor includes a second means for shifting the natural frequency of the motor to the frequency value outside the range of 2500 Hz to 3500 Hz, the second shifting means being configured to apply a compressive force to the ring of the stator core.

Other features and aspects of the disclosure will become apparent by consideration of the following detailed description and accompanying drawings.

### BRIEF DESCRIPTION OF THE DRAWINGS

FIG. 1A is a reproduction of equal-loudness Fletcher-Munson curves over various frequencies and sound pressure levels.

FIG. 1B is a cross-sectional view of a known brushless direct current electric motor.

FIG. 2 is an end view of a brushless direct current electric motor in accordance with an embodiment of the disclosure, including added material portions applied to a stator ring.

FIG. 3 is an end view of a brushless direct current electric motor in accordance with an embodiment of the disclosure, including reduced material portions taken from a stator ring.

FIG. 4 is an end view of a brushless direct current electric motor in accordance with an embodiment of the disclosure, with a stator including circumferentially alternating stiff portions and flexible portions.

FIG. 5 is an end view of a brushless direct current electric motor in accordance with an embodiment of the disclosure, with a stator including enlarged thickness teeth.

FIG. 6 is an end view of a brushless direct current electric motor in accordance with an embodiment of the disclosure, including trapezoid-shaped added material portions applied to a stator ring.

FIG. 7 is an end view of a brushless direct current electric motor in accordance with an embodiment of the disclosure, including rectangular reduced material portions taken from a stator ring.

FIG. 8 is an end view of a brushless direct current electric motor in accordance with an embodiment of the disclosure, including trapezoid-shaped reduced material portions taken from a stator ring.

FIG. 9A is an end view of a brushless direct current electric motor in accordance with an embodiment of the disclosure, including a ring circumscribing a stator.

FIG. 9B is a perspective view of a hose clamp that may be used instead of the ring of FIG. 9A to circumscribe the stator.

Other features and aspects of the disclosure will become apparent by consideration of the detailed description and accompanying drawings.

### DETAILED DESCRIPTION

One consideration of the current disclosure is to reduce the human perceptible sound generated by motors when resonating at their natural frequency. To do so, mass and/or stiffness properties of the motor are adjusted to shift the natural frequency of the motor away from frequencies sensitive to the human ear (e.g., about 2,500 Hz to about 3,500 Hz). As such, even if motors resonate at their natural frequencies, the vibration thereof is less perceptible to the human ear. Various arrangements to achieve this goal are described below.

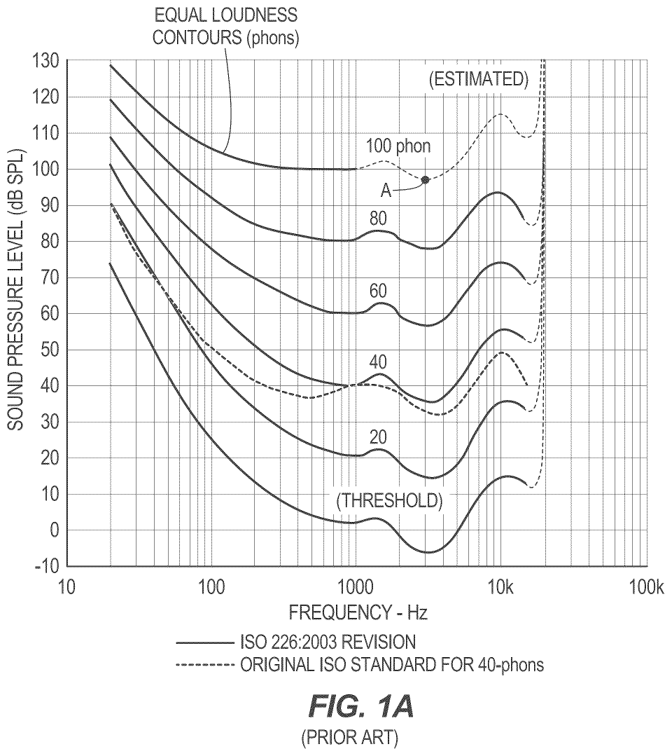

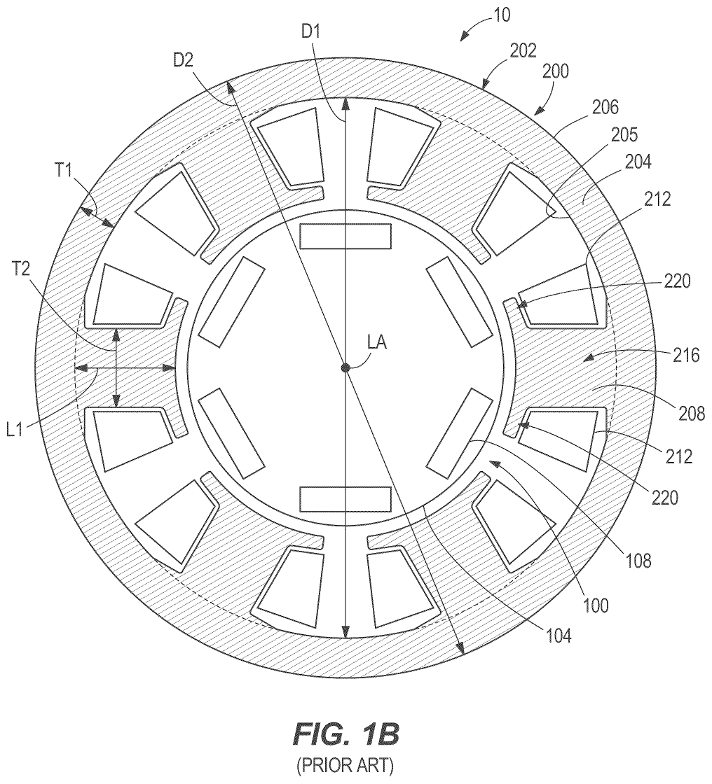

FIG. 1A illustrates various equal-loudness Fletcher-Munson curves. These curves are known in the field of acoustics, and illustrate equal loudness contours (in the unit, phons) throughout a range of sound pressure levels (in decibels, dB) and a range of frequencies (in Hertz, Hz). The threshold Fletcher-Munson curve represents a lower threshold of hearing of the human ear. The 100 phon Fletcher-Munson curve represents a threshold of feeling of the human ear-above which, sound is painful. An area between the threshold (i.e., 0 phon) Fletcher-Munson curve and the 100 phon Fletcher-Munson curve represents the auditory area of the human car. Point A on the 100 phon Fletcher-Munson curve illustrates that human cars are most sensitive around 3,000 Hz.

FIG. 1B illustrates a cross-sectional view of a brushless direct current electric motor 10 including a rotor 100 and a stator 200. The rotor 100 includes a rotor body 104 and a plurality of magnets 108 coupled to the rotor body 104. The illustrated rotor magnets 108 are circumferentially arranged about the rotor body 104 and may be alternately magnetized in the circumferential direction. The stator 200 includes a stator core 202 having a ring 204 and a plurality of teeth 208 extending radially inward from the ring 204. The stator 200 also includes a plurality of stator coils 212 wound about the teeth 208. The illustrated stator 200 is an outer stator configured for use in motors 10 with an inner rotor 100. The ring 204 is annular and includes an inner surface 205 and an outer surface 206 that is opposite to the inner surface 205. Specifically, the outer surface 206 is radially outward relative to the inner surface 205. In the illustrated embodiment, the stator 200 is oriented about a longitudinal axis LA. The teeth 208 of the illustrated outer stator 200 extend inwardly from the inner surface 205 of the ring 204. In other words, the teeth 208 extend in a direction from the ring 204 toward the longitudinal axis LA. In the illustrated embodiment, the teeth 208 are oriented in a direction perpendicular to the longitudinal axis LA. However, inner stator motors (not shown) having teeth extending outwardly from rings (i.e., outer surfaces of rings, away from the longitudinal axis LA) are well known. The stator teeth 208 are spaced from one another and arranged circumferentially about the longitudinal axis LA. The stator teeth 208 each include a body portion 216 and a pair of tip portions 220 extending in a circumferential direction away from the body portion 216 and towards adjacent stator teeth 208.

The rotor 100 and the stator 200 may each either be made of a single body (i.e., a one-piece rotor core, a one-piece stator core) or of a plurality of components. In some instances, the rotor 100 and/or the stator 200 may include a plurality of laminations stacked upon one another in an axial direction along the longitudinal axis LA.

For comparison with the embodiments of this application, some dimensions of the stator 200 are annotated. As annotated in FIG. 1B, the inner surface 205 defines an inner diameter D1 of the ring 204, and the outer surface 206 defines an outer diameter D2 of the ring 204. As measured in a radial direction relative to the longitudinal axis LA, the ring 204 includes a generally constant thickness T1 between the inner surface 205 and outer surface 206 and about the circumference thereof. As measured in a direction tangent to the longitudinal axis LA, the teeth 208 include a thickness T2. As measured in a direction radially perpendicular to the longitudinal axis LA and between the ring 204 and the tip portions 220, the teeth 208 includes a length L1.

Each of the embodiments described below relate to providing a differently arranged stator 300-600 for purposes of mitigating perceptible sound generated by the motor 10. Each stator 300-600 includes a sound mitigating feature 350-650 configured to shift the natural frequency of the motor 10 away from frequencies sensitive to the human ear (e.g., about 2,500 Hz to about 3,500 Hz).

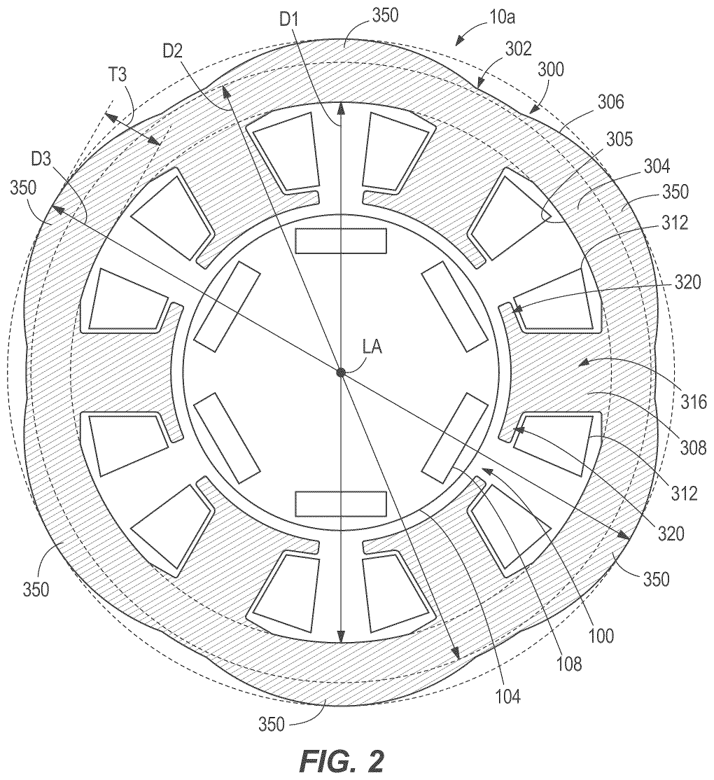

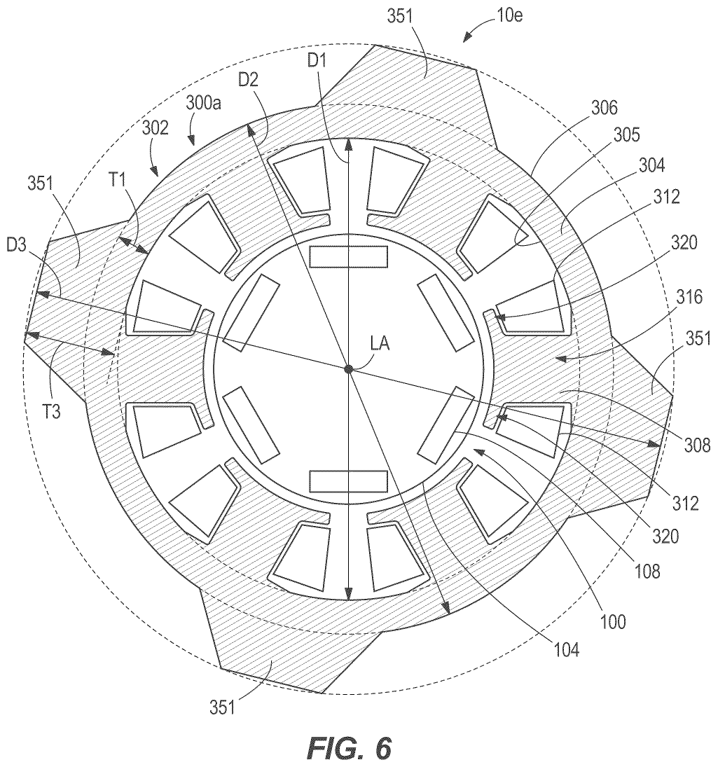

FIG. 2 illustrates a motor 10a and stator 300 including a sound mitigating feature 350 in accordance with a first embodiment of the disclosure. The stator 300 further includes like structure similar to the stator 200, with like features annotated with similar numbers in the ‘300’ series of reference numerals. The sound mitigating feature 350 in this first embodiment is a plurality of added material portions 350 provided on the ring 304. The added material portions 350 in the illustrated embodiment are positioned on an outer surface 306. The added material portions 350 are shaped such that the outer surface 306 represents a wave (e.g., an oscillating surface). The added material portions 350 are located circumferentially between adjacent teeth 308 of the stator 300. In other words, the added material portions 350 are circumferentially offset from the teeth 308. However, added material portions 350 of other shapes and positions are possible. For example, FIG. 6 illustrates another motor 10e and stator 300a including added material portions 351 which are shaped as trapezoids. The added material portions 351 are at least partially radially aligned with the teeth 308, and at least partially offset from the teeth 308. As illustrated in FIG. 6, the quantity of added material portions 351 (e.g., four) may differ from the quantity of teeth 308 (e.g., six).

A thickness T3 between the outer surface 306 and the inner diameter D1 measured through the added material portions 350 is larger than the thickness T1 between the inner surface 205 and outer surface 206 of the ring 204 at positions not in alignment with the added material portions 350. In some embodiments, the thickness T3 is greater than or equal to 50% larger than the thickness T1. In other embodiments, the thickness T3 is greater than or equal to 30% larger than the thickness T1. In some embodiments, the thickness T3 may be greater than 30% and lesser than 50% larger than the thickness T1. In other embodiments, the thickness T3 may be greater than or equal to 100% larger than the thickness T1. At thickest portions of the added material portions 350, the added material portions 350 provide a diameter D3 that is greater than the outer diameter D2 of the stator ring 204. In some embodiments, the diameter D3 may be between 2% and 50% greater than the outer diameter D2. In other embodiments, the diameter D3 may be between 5% and 25% greater than the outer diameter D2. In the illustrated embodiment, the diameter D3 at the added material portions 350 (FIG. 2) is approximately 8% greater than the outer diameter D2. Similarly, the diameter D3 at the added material portions 351 (FIG. 6) is approximately 20% greater than the outer diameter D2.

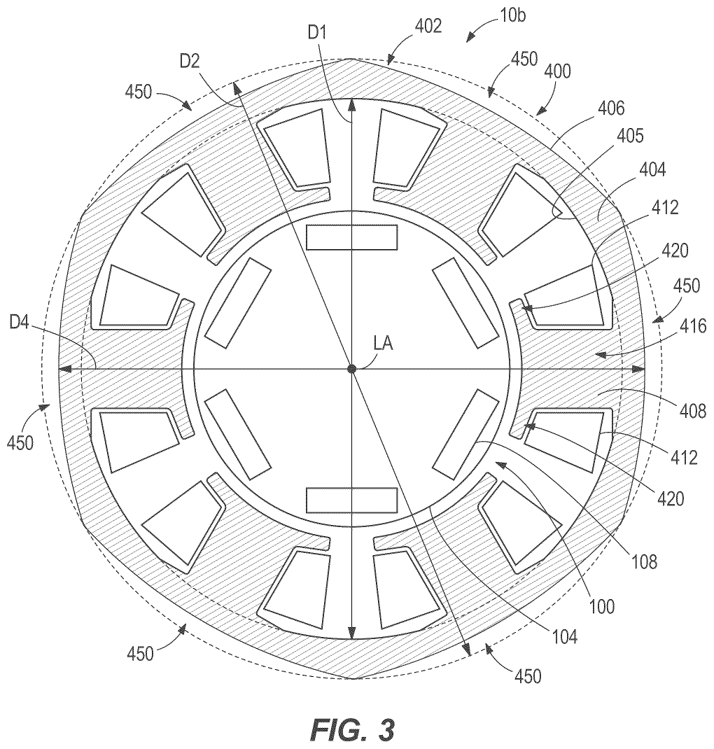

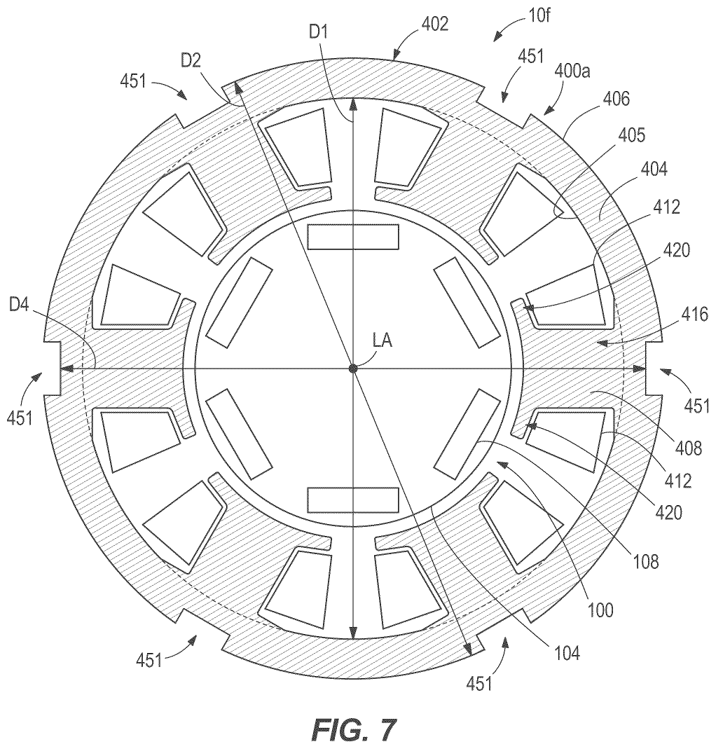

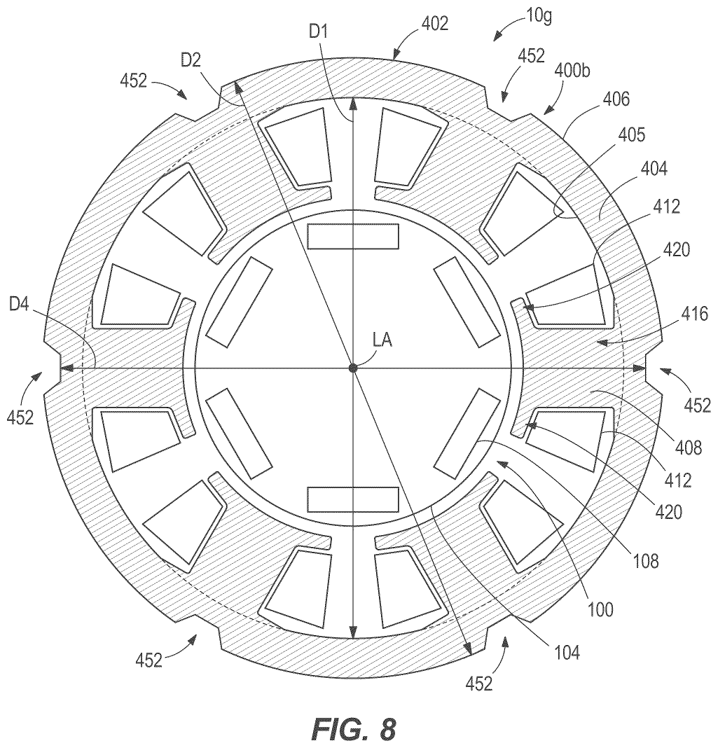

FIG. 3 illustrates a motor 10b and stator 400 including a sound mitigating feature 450 in accordance with a second embodiment of the disclosure. The stator 400 further includes structure similar to the stator 200, with like features annotated with similar numbers in the ‘400’ series of reference numerals. The sound mitigating feature 450 in this second embodiment is a reduced material portion 450 taken from the ring 404. The illustrated reduced material portion 450 is generally crescent-shaped. However, reduced material portions 450 of other shapes are possible. For example, FIG. 7 illustrates another motor 10f and stator 400a including reduced material portions 451 which are rectangular. The reduced material portions 451 are radially aligned with the teeth 408. Similarly, FIG. 8 illustrates another motor 10g and stator 400b including reduced material portions 452 which are shaped as trapezoids. More specifically, the stator 400 includes a plurality of reduced material portions 450 spaced from one another circumferentially about the longitudinal axis LA. In the illustrated embodiment, the reduced material portions 450 are voids in the ring 404 which locate the outer surface 406 of the ring 404 closer to the longitudinal axis LA in comparison with portions of the ring 404 aligned with gaps between adjacent stator teeth 408. In the illustrated embodiment, a diameter D4 measured between outer surface 406 of the ring 404 at circumferential locations corresponding to reduced material portions 450 is larger than the inner diameter D1 of the ring 204, and smaller than the outer diameter D2 of the ring 204. In some embodiments, the diameter D4 may be approximately 50% between a difference between the inner diameter D1 and the outer diameter D2. For example, the diameter D4 may be between 25% and 75% of a difference between the inner diameter D1 and the outer diameter D2.

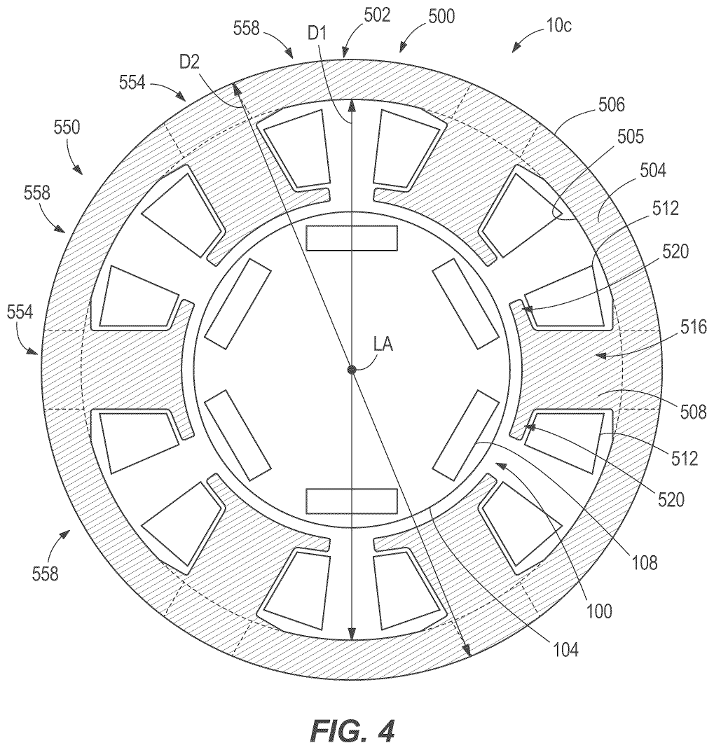

FIG. 4 illustrates a motor 10c and stator 500 including a sound mitigating feature 550 in accordance with a third embodiment of the disclosure. The stator 500 further includes structure similar to the stator 200, with like features annotated with similar numbers in the ‘500’ series of reference numerals. The sound mitigating feature 550 in this third embodiment includes circumferentially alternating stiff portions 554 and flexible portions 558. In the illustrated embodiment, the stator 500 includes stiff portions 554 in radial alignment with the stator teeth 508 and with respect to the longitudinal axis LA. The stator 500 includes flexible portions 558 in radial alignment with gaps between adjacent stator teeth 508. A stiffness of the stiff portions 554 is higher than a stiffness of the flexible portions 558. The sound mitigating feature 550 adjusts the stiffness of the stator 500, and thus, the motor 10c. Optionally, materials forming the stiff portions 554 and the flexible portions 558 differ. In other embodiments, the stator 500 may include other structural differences (e.g., presence of lattice structure, solid bodies, etc.) to differentiate the stiff portions 554 and the flexible portions 558. Optionally, the mass of the stator 500 differs from the mass of the stator 200. In the illustrated embodiment of FIG. 4, radially extending dashed lines demarcate a separation between the stiff portions 554 and the flexible portions 558. In some embodiments, these demarcations may be visible. In other embodiments, demarcations between stiff portions 554 and flexible portions 558 may be invisible.

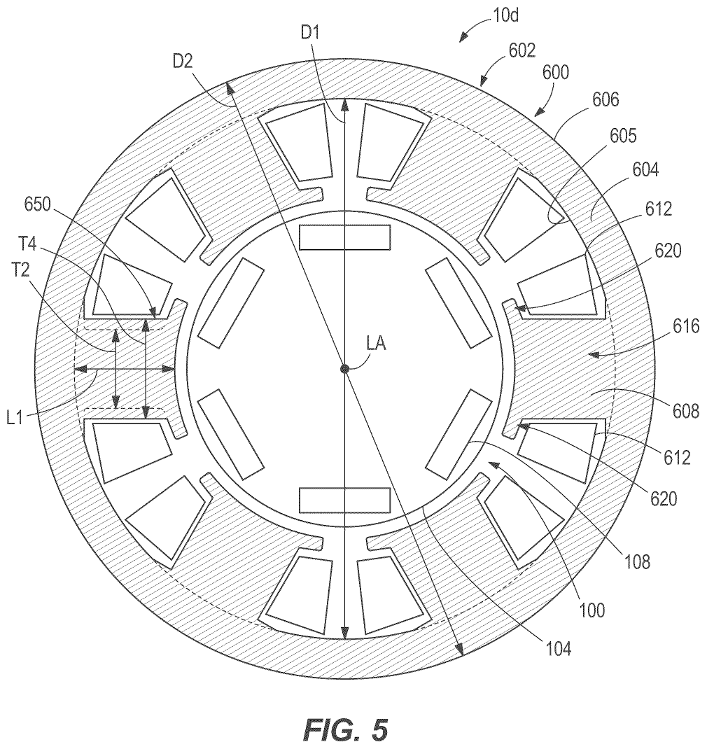

FIG. 5 illustrates a motor 10d and stator 600 including a sound mitigating feature 650 in accordance with a fourth embodiment of the disclosure. The stator 600 further includes structure similar to the stator 200, with like features annotated with similar numbers in the ‘600’ series of reference numerals. The sound mitigating feature 650 in this fourth embodiment is enlarged thickness stator teeth 650. As measured in a direction tangent to the longitudinal axis LA, the enlarged thickness stator teeth 650 include a thickness T4 greater than the thickness T2 of the stator teeth 208. In the illustrated embodiment, the stator core 602 is a single piece (i.e., monolithic construction). In some embodiments, the thickness T4 of the enlarged thickness stator teeth 650 may be approximately 1 millimeter greater than the thickness T2 of the stator teeth 208. In other embodiments, the thickness T4 of the enlarged thickness stator teeth 650 may be approximately 2 millimeters greater than the thickness T2 of the stator teeth 208. In other embodiments, the thickness T4 of the enlarged thickness stator teeth 650 may be approximately 4 millimeters greater than the thickness T2 of the stator teeth 208. In other embodiments, the thickness T4 of the enlarged thickness stator teeth 650 may be greater than the thickness T2 of the stator teeth 208, and equal to or lesser than 50% thicker than the stator teeth 208. In other embodiments, the thickness T4 of the enlarged thickness stator teeth 650 may be between 10% and 60% larger than the thickness T2 of the stator teeth 208. The stator teeth 650 have a similar length L1 in comparison with the stator teeth 208. Thus, a ratio of thickness (T4) per unit length (L1) of the stator teeth 650 of the illustrated stator 600 is greater than a ratio of thickness (T2) per unit length (L1) of the stator 200.

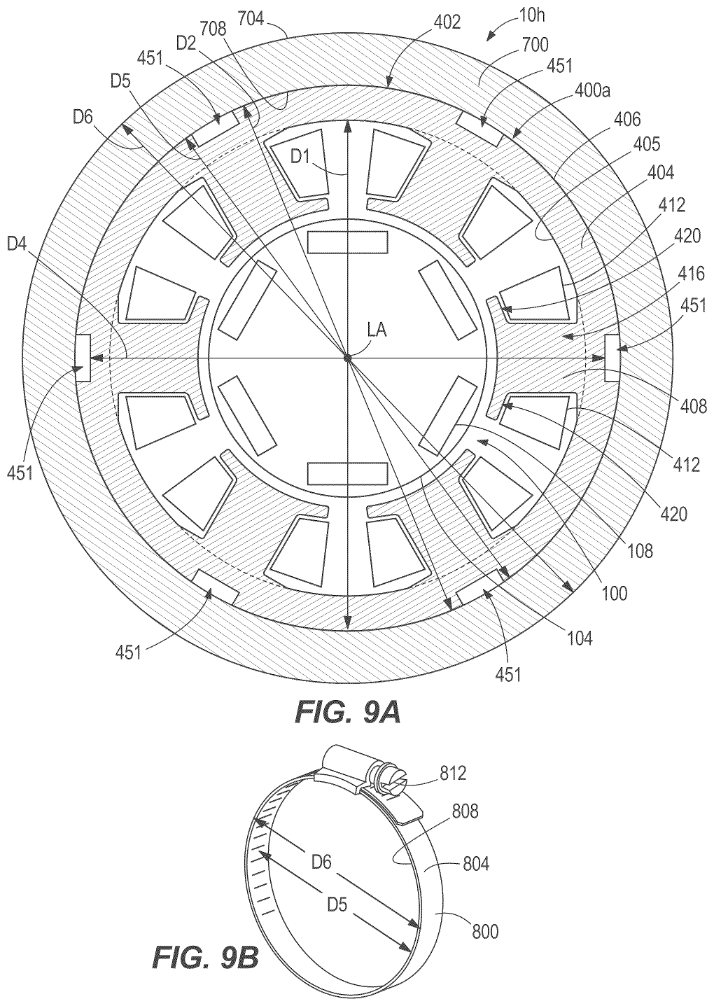

FIG. 9A illustrates a motor 10h including, for example, a stator 400 and a ring 700 (e.g., a shrink ring) circumscribing the stator 400. The ring 700 itself functions as a sound mitigating feature of the motor 10h. The motor 10h may be constructed with the stator 400 or any other suitable stator (e.g., any of stators 200, 300, 400, 500, 600, or the like). The stator 400 is positioned circumferentially within the ring 700. The ring 700 provides circumferential support to the stator 400 in a radially inwardly extending direction which extends from the ring 700 and towards the longitudinal axis LA. The ring 700 is generally annularly shaped. The ring 700 includes an outer radial surface 704 and an inner radial surface 708. The stator 400, as described above, includes an outer surface 406 which defines an outer diameter D2. The inner radial surface 708 of the ring 700 defines an inner diameter D5. The outer radial surface 704 of the ring 700 defines an outer diameter D6. The ring 700 may be made of a hardened (e.g., stiff) material (e.g., steel), that is shrink fit around the outer surface 406 of the stator 400. The ring 700 and/or stator 400 may be heated to a temperature above room temperature (i.e., a pressing temperature) to expand the inner diameter D5 of the ring 700 until the outer diameter D2 of the stator 400 is less than the inner diameter D5 of the ring 700, at which time the stator 400 may be pressed within the ring 700. As the temperature of the ring 700 and stator 400 are returned to room temperature, the inner diameter of the ring 700 may shrink to establish a press-fit between the inner radial surface 708 of the ring 700 and the outer surface 40 of the stator 400. Thus, a compressive force is applied from the ring 700 in a radially inward direction onto the stator 400. This compressive force may shift a resonant mode frequencies of the motor 10h to a ring compressed frequency outside a range of 2500 Hz to 3500 Hz. In some embodiments, the ring compressed frequency may be greater than 10,000 Hz (10 kHz). In some embodiments, the ring compressed frequency may be greater than 30,000 Hz (30 kHz).

FIG. 9B illustrates an adjustable annular clamp 800 including an outer radial surface 804 and an inner radial surface 808. The adjustable annular clamp 800 further includes an adjustment mechanism 812 which is configured to adjust the size of the inner diameter D5 of the inner radial surface 808. When the adjustment mechanism 812 is actuated, the adjustable annular clamp 800 may compress onto or relax from the stator 400 in a similar manner to the ring 700. The adjustment mechanism 812 may be actuatable throughout the life of the motor 10h. One or more hose clamps 800 may replace the ring 700 in the motor 10h. Alternatively, one or more hose clamps 800 may be tightened upon the outer radial surface 704 of the ring 700. The adjustable annular clamp 800 itself or the adjustable annular clamp 800 and the ring 700 may function as a sound mitigating feature of the motor 10h. In other words, both the ring 700 and the adjustable annular clamp 800 are compressive sound mitigating features. In either arrangement, the one or more hose clamps 800 provide similar radially inwardly extending compressive force to the outer surface 406 of the stator 400, such that the hose clamp(s) 800 shift a resonant mode frequency of the motor 10h to a clamp compressed frequency outside a range of 2500 Hz to 3500 Hz. In some embodiments, the clamp compressed frequency is greater than 10 kHz. In some embodiments, the clamp compressed frequency is greater than 30 kHz.

It is understood that the stators 300-600 are illustrated for use with the rotor 100. The stators 300-600 and sound mitigating features 350-650 may be modified (i.e., flipped, inverted) accordingly to accommodate outer rotors (not shown).

By including the sound mitigating features 350-650, 700, 800 to the stators 300-600, at least one of the mass of the motors 10a-10h and a stiffness of the motors 10a-10h is adjusted in comparison with the motor 10. As such, a natural frequency of the motors 10a-10h including one of the stators 300-600 is different than a natural frequency of the motor 10 which includes the stator 200.

During operation of the motor 10, the stator coils 212 are energized, and an electromagnetic field emanating from the stator coils 212 is realized by the magnets 108 of the rotor 100, which causes the rotor 100 to rotate about the longitudinal axis LA and relative to the stator 200. Rotation of the rotor 100 and/or other operating vibrations caused by the rotor 100 may cause induced vibration of the stator 200, and of the motor 10 in general. In some instances, the stator 200 may be caused to vibrate at its natural frequency, at which, the stator 200 may undesirably vibrate around frequencies that human cars are most sensitive around (e.g., 3,000 Hz).

The sound mitigation features 350-650, 351, 451, 452 of the stators 300-600, 300a, 400a, 400b and the ring 700, hose clamp(s) 800 effectively adjust (i.e., tune) the natural frequency of the motors 10a-10h to a frequency other than frequencies that human cars are most sensitive around (e.g., between 2500 Hz and 3500 Hz). In some embodiments, by replacing the stator 200 with one of the stators 300-600 including a sound mitigation feature 350-650, the natural frequency of the motor 10a-10g is shifted to about 4300 Hz. In some embodiments, the natural frequency of the motors 10a-10g is shifted to between 3800 Hz and 4800 Hz. In other embodiments, the natural frequency of the motors 10a-10g is shifted to between 4000 Hz and 4600 Hz. In other embodiments, the natural frequency of the motors 10a-10h is shifted to a frequency greater than 10 kHz. In other embodiments, the natural frequency of the motors 10a-10h is shifted to a frequency greater than 30 kHz. In other embodiments, by replacing the stator 200 one of the stators 300-600, 300a, 400a, 400b including a sound mitigation feature 350-650, 351, 451, 452, and/or by further providing a ring 700 or adjustable annular clamp 800, the natural frequency of the motor 10a-10h is shifted to about 4300 Hz. In other embodiments, by replacing the stator 200 with one of the stators 300-600, 300a, 400a, 400b, the resonant frequency of the motor 10 may be shifted to a natural frequency lesser than frequencies that human cars are most sensitive around (e.g., lesser than 2500 Hz). As a result, approximately a 5 dB perceived sound reduction is possible.

Although the application has been described in detail with reference to certain preferred embodiments, variations and modifications exist within the scope and spirit of one or more independent aspects of the application as described.

Various features of the invention are set forth in the following claims.

What is claimed is:

1. A motor comprising:
a rotor including magnets therein; and
a stator including
a stator core having a ring and a plurality of teeth extending from the ring,
a plurality of coils wound around the plurality of teeth, and
a means for shifting a natural frequency of the motor to a frequency value outside a range of 2500 Hertz (Hz) to 3500 Hz.

2. The motor of claim 1, wherein the shifting means comprises added material portions applied to the ring.

3. The motor of claim 2, wherein the added material portions are circumferentially offset from the plurality of teeth.

4. The motor of claim 2, wherein the added material portions are trapezoid-shaped.

5. The motor of claim 1, wherein the shifting means comprises reduced material portions taken from the ring.

6. The motor of claim 5, wherein the reduced material portions are radially aligned with the plurality of teeth.

7. The motor of claim 5, wherein the reduced material portions are crescent-shaped.

8. The motor of claim 1, wherein the shifting means comprises circumferentially alternating stiff portions and flexible portions in the stator core.

9. The motor of claim 8, wherein the stiff portions are radially aligned with the plurality of teeth, and wherein the flexible portions are radially aligned with gaps defined between adjacent teeth.

10. The motor of claim 8, wherein a stiffness of the stiff portions is higher than a stiffness of the flexible portions.

11. The motor of claim 1, wherein the shifting means comprises enlarged thickness stator teeth.

12. A motor comprising:
a rotor including magnets therein;
a stator including
a stator core having a ring and a plurality of teeth extending from the ring,
a plurality of coils wound around the plurality of teeth; and
a means for shifting a natural frequency of the motor to a frequency value outside a range of 2500 Hertz (Hz) to 3500 Hz, the shifting means being configured to apply a compressive force to the ring of the stator core.

13. The motor of claim 12, wherein the shifting means includes a shrink ring shrink fit onto the stator.

14. The motor of claim 12, wherein the shifting means includes an annular clamp configured to be tightened onto the stator.

15. The motor of claim 14, wherein the annular clamp includes an adjustment mechanism configured to be actuated to adjust an amount of compressive force applied to the stator by the clamp.

16. A motor comprising:
a rotor including magnets therein;
a stator including
a stator core having a ring and a plurality of teeth extending from the ring,
a plurality of coils wound around the plurality of teeth,
a first means for shifting a natural frequency of the motor to a frequency value outside a range of 2500 Hertz (Hz) to 3500 Hz; and
a second means for shifting the natural frequency of the motor to the frequency value outside the range of 2500 Hz to 3500 Hz, the second shifting means being configured to apply a compressive force to the ring of the stator core.

17. The motor of claim 16, wherein the first shifting means comprises reduced material portions taken from the ring.

18. The motor of claim 17, wherein the reduced material portions are radially aligned with the plurality of teeth, and wherein the reduced material portions are rectangular.

19. The motor of claim 18, wherein the second shifting means includes a shrink ring that is shrink fit onto the stator.

20. The motor of claim 19, wherein the frequency value is greater than 10,000 Hz.
